(19) United States
(12) Patent Application Publication
(10) Pub. No.: US 2016/0161800 A1
(43) Pub. Date: Jun. 9, 2016

(54) POLARIZING PLATE AND IMAGE DISPLAY DEVICE

(71) Applicant: FUJIFILM Corporation, Tokyo (JP)

(72) Inventors: Megumi SEKIGUCHI, Kanagawa (JP); Ryo SATAKE, Kanagawa (JP)

(73) Assignee: FUJIFILM Corporation, Tokyo (JP)

(21) Appl. No.: 15/046,976

(22) Filed: Feb. 18, 2016

Related U.S. Application Data
(63) Continuation of application No. PCT/JP2014/073744, filed on Sep. 9, 2014.

(30) Foreign Application Priority Data
Sep. 12, 2013 (JP) 2013-189676
Nov. 6, 2013 (JP) 2013-230196

(51) Int. Cl. G02F 1/1335; G02B 1/14; G02B 5/30

(52) U.S. Cl. CPC G02F 1/133528; G02B 5/3033; G02B 1/14

(57) ABSTRACT

An object of the present invention is to provide a polarizing plate having a surface with excellent pencil hardness and an image display device for which the polarizing plate is used. The polarizing plate of the present invention is a polarizing plate including an outer hardcoat layer, a polarizer, and an inner hardcoat layer in this order and forming an image display device when a display element is provided on a side opposite to a side of the inner hardcoat layer on which the polarizer is present, in which the inner hardcoat layer and the outer hardcoat layer satisfy a relationship of Expression (I) below, and a thickness is 80 μm or smaller.

Hᵢₙ>Hₒᵤₜ Expression (I)

Here, Hᵢₙ represents a value of a thickness×a modulus of elasticity of the inner hardcoat layer, and Hₒᵤₜ represents a value of a thickness×a modulus of elasticity of the outer hardcoat layer.

### CROSS-REFERENCE TO RELATED APPLICATIONS

This application is a Continuation of PCT International Application No. PCT/JP2014/073744 filed on Sep. 9, 2014, which claims priority under 35 U.S.C. §119(a) to Japanese Patent Application No. 2013-189676 filed on Sep. 12, 2013 and Japanese Patent Application No. 2013-230196 filed on Nov. 6, 2013. Each of the above application(s) is hereby expressly incorporated by reference, in its entirety, into the present application.

### BACKGROUND OF THE INVENTION

1. Field of the Invention

The present invention relates to a polarizing plate and an image display device. Specifically, the present invention relates to a polarizing plate including an outer hardcoat layer and an inner hardcoat layer and an image display device including the same.

2. Description of the Related Art

Recently, an attempt has been underway to decrease the thickness of an image display device, particularly, a liquid crystal display device for medium and small-size applications, and accordingly, there has been a demand for decreasing the thickness of a member (for example, a polarizing plate) used in an image display device. Examples of a method for decreasing the thickness of a polarizing plate include a method for thinning a polarizer or a protective film for a polarizer, a method for eliminating the necessity of a protective film or a retardation film disposed between a polarizer and a liquid crystal cell, and the like.

Meanwhile, as the thickness of a polarizing plate decreases, there has been a problem in that the pencil hardness of the surface of the polarizing plate deteriorates and damage is likely to be caused in the polarizing plate during the transport of the polarizing plate or the transport of a liquid crystal panel.

As a method for improving the pencil hardness of the surface of a polarizing plate, a method in which a hardcoat layer is disposed is known, but there have been cases in which, when the thickness of the polarizing plate is decreased, the hardcoat layer which has been generally used thus far is not sufficiently improved.

Concerning the above-described problem, for example, JP2013-513832A describes “a polarizing plate having a multilayer film thickness of 65 μm obtained by laminating hard coating films on both surfaces of a polarizer PVA film using an adhesive” (“0040”).

### SUMMARY OF THE INVENTION

The present inventors clarified that, even in a case in which hardcoat layers are disposed on both surfaces of a polarizer as described in JP2013-513832A, there are cases in which the pencil hardness of the surface of a polarizing plate is insufficient.

Therefore, an object of the present invention is to provide a polarizing plate having a surface with excellent pencil hardness even in a case in which the thickness of the polarizing plate is decreased and an image display device for which the polarizing plate is used.

The present inventors carried out intensive studies in order to achieve the above-described object, and, consequently, found that, when the value of the thickness×the modulus of elasticity of an inner hardcoat layer is set to be greater than the value of the thickness×the modulus of elasticity of an outer hardcoat layer, it is possible to improve the pencil hardness of the surface of a polarizing plate even in a case in which the total thickness of the polarizing plate is decreased, and completed the present invention.

That is, it was found that the following constitutions are capable of achieving the above-described object.

[1]A polarizing plate including an outer hardcoat layer, a polarizer, and an inner hardcoat layer in this order, in which the polarizing plate forms an image display device by providing a display element on a side opposite to a side of the inner hardcoat layer on which the polarizer is present, the inner hardcoat layer and the outer hardcoat layer satisfy a relationship of Expression (I) below, and a thickness is 80 μm or smaller,

Hᵢₙ>Hₒᵤₜ Expression (I)

here, Hᵢₙ represents a value of a thickness×a modulus of elasticity of the inner hardcoat layer, and Hₒᵤₜ represents a value of a thickness×a modulus of elasticity of the outer hardcoat layer.

[2] The polarizing plate according to [1], in which the outer hardcoat layer is provided on a surface of the polarizer.

[3] The polarizing plate according to [1], in which at least one polymer film is provided between the outer hardcoat layer and the polarizer.

[4] The polarizing plate according to any one of [1] to [3], in which a thickness of the polarizer is 25 μm or smaller.

[5] The polarizing plate according to any one of [1] to [4], in which the modulus of elasticity of the inner hardcoat layer and the modulus of elasticity of the outer hardcoat layer are respectively in a range of 1 GPa to 6 GPa.

[6] The polarizing plate according to any one of [1] to [5], in which the thickness of the inner hardcoat layer is larger than the thickness of the outer hardcoat layer.

[7] The polarizing plate according to any one of [1] to [6], in which a value of a ratio between the thickness of the inner hardcoat layer and the thickness of the outer hardcoat layer is in a range of greater than 1 to 5.

[8] The polarizing plate according to any one of [3] to [7], in which a thickness of the polymer film is 40 μm or smaller.

[9] The polarizing plate according to any one of [3] to [8], in which the polymer film includes at least one resin material selected from a group consisting of cellulose acylate-based resins, acrylic resins, cycloolefin-based resins, and polyester-based resins.

[10] An image display device including the polarizing plate according to any one of [1] to [9] and a display element.

[11] An image display device including a liquid crystal cell and a pair of polarizing plates disposed so as to sandwich the liquid crystal cell, in which at least one of a pair of the polarizing plates is the polarizing plate according to any one of [1] to [9].

According to the present invention, it is possible to provide a polarizing plate having a surface with excellent pencil hardness even in a case in which the thickness of the polarizing plate is decreased and an image display device for which the polarizing plate is used.

### BRIEF DESCRIPTION OF THE DRAWINGS

FIGS. 1A and 1B are respectively schematic sectional views illustrating examples of an embodiment of an image display device of the present invention.

FIGS. 2A and 2B are respectively schematic sectional views illustrating additional examples of the embodiment of the image display device of the present invention.

### DESCRIPTION OF THE PREFERRED EMBODIMENTS

Hereinafter, the present invention will be described in detail.

Constitution requirements described below will be, in some cases, described based on a typical embodiment of the present invention, but the present invention is not limited to the above-described embodiment.

Meanwhile, in the present specification, numerical ranges expressed using “to” include numerical values before and after the “to” as the lower limit value and the upper limit value.

[Polarizing Plate]

A polarizing plate of the present invention is a polarizing plate including an outer hardcoat layer, a polarizer, and an inner hardcoat layer in this order and forming an image display device when a display element is provided on a side opposite to a side of the inner hardcoat layer on which the polarizer is present, in which the inner hardcoat layer and the outer hardcoat layer satisfy a relationship of Expression (I), and the thickness is 80 μm or smaller.

In the present invention, the thickness of the polarizing plate is preferably 65 μm or smaller and more preferably 55 μm or smaller.

In the present invention, when the polarizing plate includes an outer hardcoat layer, a polarizer, and an inner hardcoat layer in this order, and the inner hardcoat layer and the outer hardcoat layer satisfy the relationship of Expression (I) as described above, the polarizing plate has a surface with favorable pencil hardness even in a case in which the thickness of the polarizing plate is decreased.

What has been described above is not clear in detail, but it is assumed as described below.

Since the surface hardness of a film is affected by the hardness of a layer adjacent to a surface opposite to a surface to which stress is applied (a layer adjacent to a layer constituting the surface to which the stress is applied), it is considered that, when the adjacent layer is soft, the surface hardness decreases, and, when the adjacent layer is hard, the surface hardness increases.

That is, it is considered that, in a case in which stress is applied to the surface of the polarizing plate on a viewer side (a side opposite to the display element), when hardcoat layers are disposed respectively on a display element side (inside) and a viewer side (outside) of the polarizer, the hardness of the polarizer disposed on the hardcoat layer on the display element side (inner hardcoat layer) becomes higher than that of a case in which the inner hardcoat layer is not provided, the surface hardness of the hardcoat layer disposed on (on the viewer side of) the polarizer in which the surface hardness increases (outer hardcoat layer) also becomes higher than that of a case in which the inner hardcoat layer is not provided, and it is possible to maintain the hardness of the polarizing plate on the surface side.

What has been described can also be assumed from that fact that the evaluation results of the pencil hardness do not change even when the thickness of the polarizer or the thickness of the polymer film is changed as described in Examples 1 to 3 below.

Here, it is considered that, when the thickness of the inner hardcoat layer is increased rather than the thickness of the outer hardcoat layer, the hardness can be increased in both the polarizer laminated on the inner hardcoat layer and the polymer film described below, and thus the effect is stronger, and the pencil hardness can be improved while suppressing an increase in the total thickness of the polarizing plate.

[Image Display Device]

An image display device of the present invention is an image display device including the above-described polarizing plate of the present invention and a display element (for example, a liquid crystal cell, an organic EL display panel, or the like).

A preferred example of the above-described image display device is an image display device including a liquid crystal cell and a pair of polarizing plates disposed so as to sandwich the liquid crystal cell, in which, as at least one of a pair of the polarizing plates, the above-described polarizing plate of the present invention, that is, a polarizing plate including an outer hardcoat layer, a polarizer, and an inner hardcoat layer in this order, in which the inner hardcoat layer and the outer hardcoat layer satisfy a relationship of Expression (I) below, and a thickness is 80 μm or smaller is used.

Hᵢₙ>Hₒᵤₜ Expression (I)

Here, Hᵢₙ represents a value of a thickness×a modulus of elasticity of the inner hardcoat layer, and Hₒᵤₜ represents a value of a thickness×a modulus of elasticity of the outer hardcoat layer.

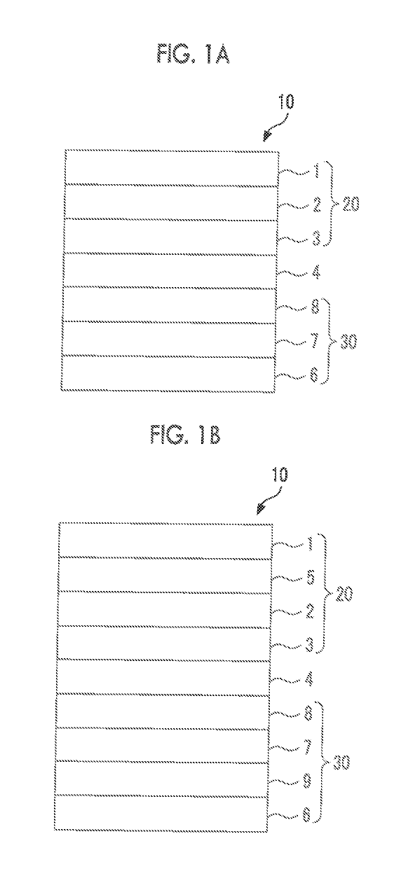

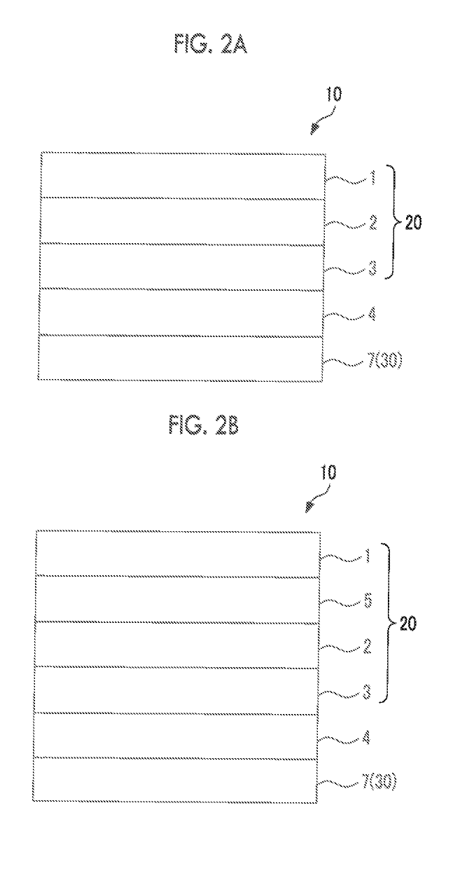

Next, the overall constitution of the image display device of the present invention will be described using FIGS. 1A and 1B and FIGS. 2A and 2B, and then individual constitutions of the image display device and the polarizing plate will be described in detail.

FIGS. 1A and 1B illustrate schematic sectional views illustrating examples of an embodiment (liquid crystal display device) of the image display device of the present invention.

As illustrated in FIG. 1A, a liquid crystal display device 10 is a liquid crystal display device including a liquid crystal cell 4 and a pair of polarizing plates (reference sign 20: a front-side polarizing plate, reference sign 30: rear-side polarizing plate) disposed so as to sandwich the liquid crystal cell 4, in which each of a pair of the polarizing plates includes an outer hardcoat layer (reference sign 1 or 6), a polarizer (reference sign 2: front-side polarizer, reference sign 7: rear-side polarizer), and an inner hardcoat layer (reference sign 3 or 8) in this order, and the outer hardcoat layer, the polarizer, the inner hardcoat layer, and the liquid crystal cell are disposed in this order.

In addition, as illustrated in FIG. 1B, at least one polymer film (reference sign: 5 or 9) may be provided between the outer hardcoat layer and the polarizer.

FIGS. 2A and 2B illustrate schematic sectional views illustrating additional examples of the embodiment (liquid crystal display device) of the image display device of the present invention.

As illustrated in FIG. 2A, the liquid crystal display device 10 is a liquid crystal display device including the liquid crystal cell 4 and a pair of the polarizing plates (reference sign 20: a front-side polarizing plate, reference sign 30: rear-side polarizing plate) disposed so as to sandwich the liquid crystal cell 4, in which, out of a pair of the polarizing plates, only the front-side polarizing plate 20 includes the outer hardcoat layer 1, the front-side polarizer 2, and the inner hardcoat layer 3 in this order, and the outer hardcoat layer 1, the front-side polarizer 2, the inner hardcoat layer 3, and the liquid crystal cell 4 are disposed in this order.

In addition, as illustrated in FIG. 2B, at least one polymer film 5 may be provided between the outer hardcoat layer 1 and the front-side polarizer 2.

In the present invention, it is preferable that, out of a pair of the polarizing plates, at least the front-side polarizing plate includes the outer hardcoat layer, the polarizer, and the inner hardcoat layer in this order, and the inner hardcoat layer and the outer hardcoat layer satisfy the relationship of Expression (I) as illustrated in FIGS. 1A and 1B and FIGS. 2A and 2B.

In addition, since it is possible to decrease the thickness of the polarizing plate, a polymer film is preferably not provided between the outer hardcoat layer and the polarizer, and the outer hardcoat layer is preferably disposed on the surface of the polarizer. In addition, for the same reason, the inner hardcoat layer is preferably disposed on the surface of the polarizer.

Meanwhile, since it is easy to ensure the light resistance of the polarizer while further improving the pencil hardness of the polarizing plate, at least one polymer film is preferably provided between the outer hardcoat layer and the polarizer. In addition, an ultraviolet absorbent is preferably added to the polymer film.

[Hardcoat Layer]

Regarding the hardcoat layers used in the present invention, in at least one polarizing plate out of a pair of the polarizing plates, the outer hardcoat layer, the polarizer, and the inner hardcoat layer are disposed in this order, and the inner hardcoat layer and the outer hardcoat layer satisfy the relationship of Expression (I) below.

Meanwhile, in the present invention, in any one polarizing plate out of a pair of the polarizing plates (the rear-side polarizing plate 30 in FIGS. 2A and 2B), the hardcoat layer may not be provided on the inside (liquid crystal cell side) or outside (viewer side or backlight side) of the polarizer.

Hᵢₙ>Hₒᵤₜ Expression (I)

Here, Hᵢₙ, represents a value of a thickness×a modulus of elasticity of the inner hardcoat layer, and Hₒᵤₜ represents a value of a thickness×a modulus of elasticity of the outer hardcoat layer.

Regarding the thicknesses of the hardcoat layers, since it is possible to decrease the thickness of the polarizing plate and further improve the brittleness of the polarizing plate, the thickness of the outer hardcoat layer and the thickness of the inner hardcoat layer are both preferably 25 μm or smaller and more preferably 15 μm or smaller.

Meanwhile, since it is possible to further improve the pencil hardness of the surface of the polarizing plate, the thickness of the outer hardcoat layer and the thickness of the inner hardcoat layer are both preferably 2 μm or larger and more preferably 5 μm or larger.

Regarding the moduli of elasticity of the hardcoat layers, since it is possible to further improve the pencil hardness of the surface of the polarizing plate and further improve the brittleness of the polarizing plate, the moduli of elasticity of the inner hardcoat layer and the outer hardcoat layer are respectively preferably in a range of 1 GPa to 6 GPa, more preferably in a range of 2 GPa to 5.5 GPa, and still more preferably in a range of 3.5 GPa to 5.5 GPa.

<Method for Measuring Modulus of Elasticity of Hardcoat Layer>

In the present invention, the modulus of elasticity of the hardcoat layer is measured using the following method.

A laminate of the hardcoat layer and a film having known properties is prepared, the modulus of elasticity (Es) of the film and the modulus of elasticity (Ec) of the laminate of the hardcoat layer and the film are obtained from the initial slopes of the stress-strain curves of the film and the laminate which are obtained using a tensile strength tester, and the modulus of elasticity (Ef) of the hardcoat layer is computed using individual equations of internal stress described below. Here, a tensile test is carried out with a load applied in a range in which the hardcoat layer does not rupture.

σc(b+d)=σfd+σsb

Ec(b+d)=Efd+Esb

.^{.}. Ef=(Ec(b+d)−Esb)/d

σc: The internal stress of the laminate of the hardcoat layer and the film

σf: The internal stress of the hardcoat layer

σs: The internal stress of the film

Ec: The modulus of elasticity of the laminate of the hardcoat layer and the film

Ef: The modulus of elasticity of the hardcoat layer

Es: The modulus of elasticity of the film

b: The thickness of the film

d: The thickness of the hardcoat layer

Meanwhile, as the film having known properties, the polarizer or the polymer film used in the image display device and the polarizing plate of the present invention may be used.

In a case in which the hardcoat layers are provided on both surfaces of the polarizer or the polymer film, the modulus of elasticity is measured after the hardcoat layer which is not a measurement subject is peeled off.

In addition, the modulus of elasticity refers to the minimum value among the moduli of elasticity of a total of eight specimens having a length of 100 mm in a measurement direction and a width of 10 mm cut out from the hardcoat layer at intervals of 45 degrees with respect to the measurement direction. In addition, the modulus of elasticity of each specimen was computed from the slope between stress values measured at 0.1% elongation and 0.5% elongation when the specimen was left to stand in an environment of 25° C. and a relative humidity of 60% for 24 hours and then, immediately, was stretched in an atmosphere of 25° C. and a relative humidity of 60% using a universal tensile tester “STM T50BP” manufactured by Toyo Baldwin Co., Ltd. at an interchuck distance of 100 mm and a tensile rate of 10/minute.

In addition, in a case in which the specimen size does not satisfy 100 mm×10 mm, the modulus of elasticity can be obtained from the minimum value among the moduli of elasticity of a total of eight specimens prepared by cutting out specimens having a humidity adjusted at 25° C. and a relative humidity of 60% for three days from the hardcoat layer at intervals of 45 degrees with respect to the measurement direction so that the length in a measurement direction reached 35 mm and the width reached 5 mm. Meanwhile, in this case, the modulus of elasticity of each specimen is computed by setting the environment of a measurement chamber to a relative humidity of 60% using a dynamic viscoelasticity analyzer (DVA-225, manufactured by IT Keisokuseigyo Kabushiki Kaisha), measuring the moduli of elasticity in a tensile mode at a frequency of 1 Hz and a displacement amplitude of 0.02 mm in a temperature range of 0° C. to 100° C. while increasing the temperature at 2° C./minute, and averaging the values in a temperature range of 20° C. to 30° C.

In addition, since it is possible to further improve the pencil hardness of the surface of the polarizing plate and further improve the brittleness of the polarizing plate, the thickness of the inner hardcoat layer is preferably larger than the thickness of the outer hardcoat layer. In addition, the ratio between the thickness of the inner hardcoat layer and the thickness of the outer hardcoat layer is preferably in a range of greater than 1 to 5, more preferably in a range of 1.1 to 4, and still more preferably in a range of 1.5 to 2.5.

As a material for the hardcoat layers used in the present invention, an ordinary material used for the hardcoat layer can be used. The same material or different materials may be used for the outer hardcoat layer and the inner hardcoat layer. Since it is possible to simplify the process and reduce the costs, it is preferable to use the same material for the outer hardcoat layer and the inner hardcoat layer.

In addition, the hardcoat layer is preferably formed by means of a crosslinking reaction or a polymerization reaction of an ionizing radiation-curable compound.

For example, the hardcoat layer can be formed by applying a coating composition including an ionizing radiation-curable polyfunctional monomer or an ionizing radiation-curable polyfunctional oligomer onto a protective layer described below and crosslinking or polymerizing the polyfunctional monomer or the polyfunctional oligomer.

As the ionizing radiation-curable polyfunctional monomer or the ionizing radiation-curable polyfunctional oligomer, light, electron beam, or radiation-polymerizable monomers or oligomers are preferred, and among these, a light-polymerizable functional group is preferred.

Examples of the light-polymerizable functional group include unsaturated polymerizable functional groups such as (meth)acryloyl groups, vinyl groups, styryl groups, and allyl groups, and among these, a (meth)acryloyl group is preferred.

In addition, for the purpose of imparting internal scattering properties, matting particles having an average particle diameter in a range of 1.0 μm to 10.0 μm and preferably in a range of 1.5 μm to 7.0 μm, for example, particles of an inorganic compound or resin particles may be added to the hardcoat layer.

The hardcoat layers used in the present invention can be produced using an ordinarily used production method. The hardcoat layer may be produced on the polarizer or the polymer film by means of direction coating or the like or may be produced by means of transfer or the like after being produced on a separate base material.

Since it is possible to decrease the number of layers and decrease the thickness of the polarizing plate, the hardcoat layer is preferably produced on the polarizer or the polymer film by means of direct coating.

[Polarizer]

The polarizer used in the present invention is not particularly limited, and an ordinarily used polarizer can be used.

Examples of the polarizer include polarizers obtained by adsorbing a dichromatic substance such as iodine or a dichromatic dye to a hydrophilic polymer film such as a polyvinyl alcohol-based film, a partially formalized polyvinyl alcohol-based film, or an ethylene/vinyl acetate copolymer-based partially saponified film and uniaxially stretching the hydrophilic polymer film; polyene-based orientation films such as dehydrated polyvinyl alcohol and dehydrochlorinated polyvinyl chloride; and the like.

Among these, polarizers made up of a polyvinyl alcohol-based film and a dichromatic substance such as iodine is preferred.

The thickness of the polarizer is not particularly limited; however, since it is possible to decrease the thickness of the polarizing plate, the thickness is preferably 25 μm or smaller and more preferably 15 μm or smaller. The lower limit of the thickness is not particularly limited, but is generally 1 μm or larger.

The modulus of elasticity of the polarizer is preferably in a range of 2 GPa to 10 GPa, more preferably in a range of 3.5 GPa to 10 GPa, and still more preferably in a range of 5 GPa to 10 GPa since it is possible to further improve the pencil hardness of the surface of the polarizing plate and further improve the brittleness of the polarizing plate.

Here, the modulus of elasticity of the polarizer refers to the minimum value among the moduli of elasticity of a total of eight specimens having a length of 100 mm in a measurement direction and a width of 10 mm cut out from the polarizer at intervals of 45 degrees with respect to the measurement direction. In addition, the modulus of elasticity of each specimen was computed from the slope between stress values measured at 0.1% elongation and 0.5% elongation when the specimen was left to stand in an environment of 25° C. and a relative humidity of 60% for 24 hours and then, immediately, was stretched in an atmosphere of 25° C. and a relative humidity of 60% using a universal tensile tester “STM T50BP” manufactured by Toyo Baldwin Co., Ltd. at an interchuck distance of 100 mm and a tensile rate of 10%/minute.

In addition, in a case in which the specimen size does not satisfy 100 mm×10 mm, the modulus of elasticity can be obtained from the minimum value among the moduli of elasticity of a total of eight specimens prepared by cutting out specimens having a humidity adjusted at 25° C. and a relative humidity of 60% for three days from the polarizer at intervals of 45 degrees with respect to the measurement direction so that the length in a measurement direction reached 35 mm and the width reached 5 mm. Meanwhile, in this case, the modulus of elasticity of each specimen is computed by setting the environment of a measurement chamber to a relative humidity of 60% using a dynamic viscoelasticity analyzer (DVA-225, manufactured by IT Keisokuseigyo Kabushiki Kaisha), measuring the moduli of elasticity in a tensile mode at a frequency of 1 Hz and a displacement amplitude of 0.02 mm in a temperature range of 0° C. to 100° C. while increasing the temperature at 2° C./minute, and averaging the values in a temperature range of 20° C. to 30° C.

[Polymer Film]

An arbitrary polymer film used in the present invention is not particularly limited, and an ordinarily used polymer film can be used.

Specific examples of a polymer constituting the polymer film include cellulose-based polymers; acrylic polymers having an acrylic acid ester polymer such as polymethyl methacrylate and lactone ring-containing polymers; thermoplastic norbornene-based polymers; polycarbonate-based polymers; polyester-based polymers such as polyethylene terephthalate and polyethylene naphthalate; styrene-based polymers such as polystyrene and acrylonitrile/styrene copolymers (AS resins); polyolefin-based polymers such as polyethylene, polypropylene, and ethylene/propylene copolymers; vinyl chloride-based polymers; amide-based polymers such as nylon and aromatic polyamide; imide-based polymers; sulfone-based polymers; polyether sulfone-based polymers, polyether ether ketone-based polymers; polyphenylene sulfide-based polymers: vinylidene chloride-based polymers; vinyl alcohol-based polymers; vinyl butyral-based polymers; arylate-based polymers; polyoxymethylene-based polymers; epoxy-based polymers; and polymers obtained by mixing the above-described polymers.

Among these, cellulose-based polymers represented by triacetyl cellulose (hereinafter, also referred to as “cellulose acylate”) can be preferably used.

In addition, from the viewpoint of workability and optical performance, acrylic polymers are also preferably used.

Examples of the acrylic polymers include polymethyl methacrylate and the lactone ring-containing polymers described in Paragraphs “0017” to “0107” of JP2009-98605A.

The thickness of the polymer film is not particularly limited; however, since it is possible to decrease the thickness of the polarizing plate, the thickness is preferably 40 μm or smaller and more preferably 25 μm or smaller. The lower limit of the thickness is not particularly limited, but is generally 5 μm or larger.

The modulus of elasticity of the polymer film is preferably in a range of 1 GPa to 6 GPa, more preferably in a range of 2 GPa to 6 GPa, and still more preferably in a range of 3 GPa to 6 GPa since it is possible to further improve the pencil hardness of the surface of the polarizing plate and further improve the brittleness of the polarizing plate.

Meanwhile, the method, apparatus, and conditions for measuring the modulus of elasticity of the polymer film are the same as the method for measuring the modulus of elasticity and the like described in the section of the polarizer.

[Display Element]

The display element used in the image display device of the present invention is not particularly limited, and examples thereof include a liquid crystal cell, an organic EL display panel, a plasma display panel, and the like.

Among these, a liquid crystal cell or an organic EL display panel is preferred, and a liquid crystal cell is more preferred. That is, the image display device of the present invention is preferably a liquid crystal display device in which a liquid crystal cell is used as the display element or an organic EL display device in which an organic EL display panel is used as the display element and more preferably a liquid crystal display device.

<Liquid Crystal Cell>

A liquid crystal cell used in a liquid crystal display device which is a preferred example of the image display device of the present invention is not particularly limited, and a variety of well-known modes of liquid crystal cells can be used.

Specific examples of the mode include an IPS mode, a VA mode, a TN mode, an OCB mode, an ECB mode, and the like.

Among these, the IPS mode is preferred since the visibility is favorable even when the retardation film is not used, and the thickness of a liquid crystal display device can be reduced.

<Organic EL Display Panel>

An organic EL display panel which is a preferred example of the image display device of the present invention is a display panel constituted using an organic EL element obtained by sandwiching an organic light-emitting layer (organic electroluminescence layer) between electrodes (between an anode and a cathode).

The constitution of the organic EL display panel is not particularly limited, and a well-known constitution is employed.

Meanwhile, preferred examples of the organic EL display device which is an example of the image display device of the present invention include an organic EL display device including the polarizing plate of the present invention, a plate having a λ/4 function (hereinafter, also referred to as “λ/4 plate”), and an organic EL display panel in this order.

Here, the “plate having a λ/4 function” refers to a plate having a function of converting linearly-polarized light with a specific wavelength to circularly-polarized light (or circularly-polarized light to linearly-polarized light), and specific examples of the λ/4 plate having a single-layer structure include stretched polymer films, retardation films including an optical anisotropic layer having a λ/4 function on a support, and the like, and specific examples of the λ/4 plate having a multilayer structure include broadband λ/4 plates obtained by laminating a λ/4 plate and λ/2 plate.

[Pressure Sensitive Adhesive and Adhesive]

In the image display device of the present invention, the polarizing plate of the present invention and the display device may be attached together using a pressure sensitive adhesive or an adhesive.

The pressure sensitive adhesive or the adhesive used in the present invention is not particularly limited, and an ordinarily used pressure sensitive adhesive (for example, an acrylic pressure sensitive adhesive) or adhesive (for example, a polyvinyl alcohol-based adhesive) can be used.

### EXAMPLES

Hereinafter, the present invention will be described in more detail on the basis of examples. Materials, used amounts, proportions, processing contents, processing orders, and the like described in the following examples can be appropriately altered within the purport of the present invention. Therefore, the scope of the present invention should not be limitedly interpreted by specific examples described below.

### Example 1

### Production of Polymer Film

<Preparation of Core Layer Cellulose Acylate Dope>

The following composition was injected into a mixing tank and was stirred together so as to dissolve individual components, thereby preparing a cellulose acetate solution.

| | |
|---|---|
| Cellulose acetate having a degree of acetyl substitution | 100 parts by mass |
| of 2.88 | |
| Ester oligomer A | 10 parts by mass |
| Polarizer durability improver (2-3) | 4 parts by mass |
| Ultraviolet absorbent (compound having the following | 2 parts by mass |
| structural formula) | |
| Methylene chloride (first solvent) | 430 parts by mass |
| Methanol (second solvent) | 64 parts by mass |

TABLE 1

| | Dicarboxylic acid | | | | | | |
|---|---|---|---|---|---|---|---|
| | | Aromatic (n) | | | | Hydroxyl | |
| Type of ester | Aliphatic (m) | Phthalic | Terephthalic | | | value | Molecular |
| oligomer | Adipic acid | acid | acid | Diol | Terminal | (mgKOH/g) | weight |
| A | 0 | 10 | 0 | Ethylene | Acetyl | 0 | 1000 |
| | | | | glycol | group | | |

Polarizer durability improver (2-3)

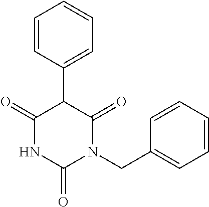 [SMILES: O=C1NC(=O)N(Cc2ccccc2)C(=O)C1c1ccccc1]

Ultraviolet absorbent

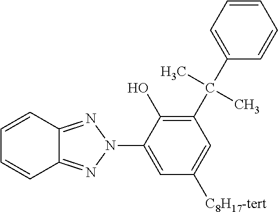

<Preparation of Outer Layer Cellulose Acylate Dope>

The following matting agent solution (10 parts by mass) was added to the core layer cellulose acylate dope (90 parts by mass), thereby preparing an outer layer cellulose acetate solution.

| | |
|---|---|
| Silica particles having an average particle size of | 2 parts by mass |
| 20 nm | |
| (AEROSIL R972, manufactured by Nippon Aerosil) | |
| Methylene chloride (first solvent) | 76 parts by mass |
| Methanol (second solvent) | 11 parts by mass |
| Core layer cellulose acylate dope | 1 part by mass |

<Production of Cellulose Acylate Film>

One layer of the core layer cellulose acylate dope and two layers of the outer layer cellulose acylate dope on both sides of the core cellulose acylate dope layer were cast at the same time on a drum (20° C.) from a casting opening. The layers were peeled off in a state in which the solvent content ratio was approximately 20% by mass, both ends of a film in the horizontal direction were fixed with tenter clips, and the film was dried while being stretched 1.1 times in the width direction in a state in which the content of the residual solvent is in a range of 3% to 15% by mass. After that, the film was further dried by being transported between rollers in a thermal treatment device, thereby producing a 25 μm-thick cellulose acylate film.

The modulus of elasticity of the produced cellulose acylate film was computed using the above-described method by preparing a total of eight specimens having a length of 100 mm in a measurement direction and a width of 10 mm cut out from the cellulose acylate film at intervals of 45 degrees with respect to the measurement direction as described above. The results are shown in Table 2 below. Meanwhile, a total of eight specimens having a length of 35 mm in a measurement direction and a width of 5 mm were cut out from the produced cellulose acylate film at intervals of 45 degrees with respect to the measurement direction, and the moduli of elasticity were measured using the above-described method, and consequently, it was found that the moduli of elasticity were almost the same values as the above-described computation results.

[Production of Outer Hardcoat Layer-Attached Polymer Film]

<Preparation of Coating Liquid for Hardcoat Layer (HC-1)>

Individual components were produced in a composition shown in the following table and were filtered using a polypropylene filter having a pore diameter of 30 μm, thereby preparing a coating liquid for a hardcoat layer HC-1.

| | |
|---|---|
| DPHA (binder) | 22.9 parts by mass |
| PET-30 (binder) | 22.9 parts by mass |
| IRGACURE184 (polymerization initiator) | 1.5 parts by mass |
| Toluene (solvent) | 45.2 parts by mass |

Compounds used will be described below.
DPHA: Dipentaerythritol hexaacrylate, a mixture of dipentaerythritol pentaacrylate [manufactured by Nippon Kayaku Co., Ltd.];
PET-30: Pentaerythritol triacrylate, a mixture of pentaerythritol tetraacrylate [manufactured by Nippon Kayaku Co., Ltd.];
IRGACURE 184: Polymerization initiator [manufactured by BASF];

<Formation of Outer Hardcoat Layer>

The coating liquid for a hardcoat layer (HC-1) was applied onto the cellulose acylate film produced above in a coating thickness set to 5 μm using a die coating method. After the coating was dried at room temperature for 120 seconds and further dried at 60° C. for 150 seconds, the coating layer was cured by being irradiated with ultraviolet rays at an illuminance of 400 mW/cm² and an irradiation intensity of 150 mJ/cm² using a 160 W/cm air cooling metal halide lamp (manufactured by Eye Graphics Co., Ltd.) while purging nitrogen (the concentration of oxygen: 0.5% or lower) so as to form an outer hardcoat layer, thereby producing an outer hardcoat layer-attached polymer film. The thickness of the outer hardcoat layer was 5 μm.

Regarding the modulus of elasticity of the formed outer hardcoat layer, the modulus of elasticity of the produced hardcoat layer-attached polymer film was computed using the same method as for the cellulose acylate film produced above, and the modulus of elasticity (Ef) of the outer hardcoat layer was computed using the respective equations of internal stress described above and a film having known properties as the cellulose acylate film produced above. The results are shown in Table 2 below. Meanwhile, a total of eight specimens having a length of 35 mm in a measurement direction and a width of 5 mm were cut out from the produced hardcoat layer-attached polymer film at intervals of 45 degrees with respect to the measurement direction, and the moduli of elasticity were measured using the above-described method, and consequently, it was found that the moduli of elasticity were almost the same values as the above-described computation results.

[Production of Polarizing Plate]

<Saponification Treatment of Polymer Film>

The produced outer hardcoat layer-attached polymer film was immersed in an aqueous solution of 2.3 mol/L of sodium hydroxide at 55° C. for three minutes. The outer hardcoat layer-attached polymer film was washed in a water-washing bath at room temperature and was neutralized using 0.05 mol/L of sulfuric acid at 30° C. Again, the hardcoat layer-attached polymer film was washed in the water-washing bath at room temperature and further dried using hot air (100° C.). A saponification treatment was carried out on the surface of the outer hardcoat layer-attached polymer film to which no hardcoat layer was attached in the above-described manner.

<Production of Polarizer>

A 75 μm-thick polyvinyl alcohol (PVA) film was dyed by being immersed in an aqueous solution of iodine having a concentration of iodine of 0.05% by mass at 30° C. for 60 seconds, then, was stretched five times while being immersed in an aqueous solution of boric acid having a concentration of boric acid of 4% by mass for 60 seconds, and then was dried at 50° C. for four minutes, thereby obtaining a 25 μm-thick polarizer.

For the obtained polarizer, as described above, a total of eight specimens having a length of 100 mm in a measurement direction and a width of 10 mm were cut out from the obtained polarizer at intervals of 45 degrees with respect to the measurement direction, and the moduli of elasticity were measured using the above-described method. The results are shown in Table 2 below. Meanwhile, a total of eight specimens having a length of 35 mm in a measurement direction and a width of 5 mm were cut out from the obtained polarizer at intervals of 45 degrees with respect to the measurement direction, and the moduli of elasticity were measured using the above-described method, and consequently, it was found that the moduli of elasticity were almost the same values as the above-described computation results.

<Attachment Between Polarizer and Outer Hardcoat Layer-Attached Polymer Film>

The saponified surface (the surface to which the outer hardcoat layer was not attached) of the outer hardcoat layer-attached polymer film that had undergone the saponification treatment was attached to a single side of the polarizer produced earlier using a polyvinyl alcohol-based adhesive, thereby producing a laminate.

<Production of Inner Hardcoat Layer>

An inner hardcoat layer was formed under the same conditions as for the outer hardcoat layer except for the fact that the coating liquid was applied onto the surface of the polarizer opposite to the surface on which the outer hardcoat layer was laminated in a coating thickness set to 10 μm using a die coating method, thereby producing a polarizing plate. The thickness of the inner hardcoat layer was 10 μm.

Regarding the modulus of elasticity of the formed inner hardcoat layer, the modulus of elasticity of the produced polarizing plate was computed using the same method as for the cellulose acylate film produced above, and the modulus of elasticity (Ef) of the inner hardcoat layer was computed using the respective equations of internal stress described above and a film having known properties as the laminate produced above. The results are shown in Table 2 below. Meanwhile, a total of eight specimens having a length of 35 mm in a measurement direction and a width of 5 mm were cut out from the produced polarizing plate at intervals of 45 degrees with respect to the measurement direction, and the moduli of elasticity were measured using the above-described method, and consequently, it was found that the moduli of elasticity were almost the same values as the above-described computation results.

### Examples 2 to 5 and Comparative Examples 1 to 11

Hereinafter, polarizing plates of Examples 2 to 5 and Comparative Examples 1 to 11 were produced in the same manner as in Example 1 except for the fact that the thickness and the like of the hardcoat layer were changed as shown in Tables 2 and 3.

Here, in Comparative Examples 3 to 8, the polarizing plates were produced without formation of the inner hardcoat layer, and, in Example 5 and Comparative Examples 9 to 11, the polymer film was not provided between the outer hardcoat layer and the polarizer, and the outer hardcoat layer was produced by being applied onto the polarizer in the same manner as the inner hardcoat layer.

Meanwhile, polymer films (thickness: 40 μm) in Example 2 and Comparative Examples 5 and 6, polarizers (thickness: 15 μm) in Example 3 and Comparative Examples 7 and 8, and an inner hardcoat layer (modulus of elasticity: 4.5 GPa) in Example 4 were produced as described below.

### Production of Cellulose Acylate Film

### Example 2 and Comparative Examples 5 and 6

Cellulose acylate films having a thickness of 40 μm after being dried were produced using the same method as in Example 1 except for the fact that the thickness of the cast film was set to 1.6 times the thickness of the cast film in Example 1 when one layer of the core cellulose acylate dope and two layers of the outer layer cellulose acylate dope on both sides of the core layer cellulose acylate dope layer were cast at the same time on a drum (20° C.) from a casting opening.

### Production of Polarizer

### Example 3 and Comparative Examples 7 and 8

A 45 μm-thick polyvinyl alcohol (PVA) film was dyed by being immersed in an aqueous solution of iodine having a concentration of iodine of 0.05% by mass at 30° C. for 60 seconds, then, was stretched five times while being immersed in an aqueous solution of boric acid having a concentration of boric acid of 4% by mass for 60 seconds, and then was dried at 50° C. for four minutes, thereby obtaining a 15 μm-thick polarizer.

### Production of Inner Hardcoat Layer

### Example 4

An inner hardcoat layer was formed under the same conditions as for the outer hardcoat layer except for the fact that a coating liquid for an inner hardcoat layer HC-2 described below was applied onto the surface of a polarizer opposite to the surface on which the outer hardcoat layer was laminated in a coating thickness set to 7.5 μm using a die coating method, and a polarizing plate was produced. The thickness of the inner hardcoat layer was 7.5 μm.

(Preparation of Coating Liquid for Inner Hardcoat Layer (HC-2))

Individual components were produced in a composition shown in the following table and were filtered using a polypropylene filter having a pore diameter of 30 μm, thereby preparing a coating liquid for an inner hardcoat layer HC-2.

| | |
|---|---|
| A-TMMT (manufactured by Shin-Nakamura | 28.4 parts by mass |
| Chemical Co., Ltd.) | |
| MEK-AC-5140Z: acrylate group-modified silica | 94.6 parts by mass |
| MEK dispersion liquid (manufactured by Nissan | |
| Chemical Industries, Ltd.) | |
| MEK | 35.0 parts by mass |
| IRGACURE127 (manufactured by BASF) | 1.7 parts by mass |

Here, the MEK-AC-5140Z blended is a dispersion liquid obtained by dispersing silica modified with an acrylate group (particle diameter: 70 nm to 100 nm) so that the concentration of solid contents reaches 30%.

[Evaluation of Pencil Hardness]

In the present invention, a pencil hardness evaluation was carried out according to JIS K 5400. The produced polarizing plate was attached to a glass plate by locking three sides of the polarizing plate using tape, the humidity was adjusted at a temperature of 25° C. and a relative humidity of 60% for 24 hours, then, a test was carried out 20 times with a load of 500 G using a 3H test pencil regulated by JIS S 6006, and the pencil hardness was evaluated using the following standards.

<Hardness Evaluation Standards>

A: During 20 rounds of the testing, the number of scratches was in a range of 0 to 5

B: During 20 rounds of the testing, the number of scratches was 6 or 7

C: During 20 rounds of the testing, the number of scratches was in a range of 8 to 16

D: During 20 rounds of the testing, the number of scratches was 17 or more

Meanwhile, the testing direction of the pencil (scratching direction) was set to be parallel to the absorption axis direction of the polarizer.

[Evaluation of Light Resistance]

A light resistance test in which the inner hardcoat layer side of the polarizing plate produced in each of the respective examples and the respective comparative examples was attached to a glass substrate using a pressure sensitive adhesive so as to produce a specimen, and the outer hardcoat layer side of the specimen was irradiated with a xenon lamp (150 W/cm², super xenon weather meter SX75 (manufactured by Suga Test Instruments Co., Ltd.)) was carried out for 15 days.

The degree of polarization of the polarizing plate that had undergone the light resistance test was measured using VAP-7070 (JASCO Corporation).

In addition, a decrease ratio was obtained from the degree of polarization using the polarizing plate of Example 1 as a standard polarizing plate and the following equation, and the light resistance was evaluated using the following evaluation standards.

Decrease ratio (%)=the degree of polarization (%) after the light resistance test of the standard polarizing plate−the degree of polarization (%) after the light resistance test of the polarizing plate of each of the examples (or each of the comparative examples)

A: The decrease ratio is lower than 0.05%

B: The decrease ratio is 0.05% or higher

TABLE 2

| | | Examples | | | | Comparative Examples | | | | | | | |
|---|---|---|---|---|---|---|---|---|---|---|---|---|---|
| | | 1 | 2 | 3 | 4 | 1 | 2 | 3 | 4 | 5 | 6 | 7 | 8 |
| Outer hardcoat layer | Thickness [μm] | 5 | 5 | 5 | 7.5 | 10 | 7.5 | 5 | 15 | 5 | 15 | 5 | 15 |
| | Modulus of elasticity [GPa] | 3.9 | 3.9 | 3.9 | 3.9 | 3.9 | 3.9 | 3.9 | 3.9 | 3.9 | 3.9 | 3.9 | 3.9 |
| | Hₒᵤₜ | 20 | 20 | 20 | 29 | 39 | 29 | 20 | 59 | 20 | 59 | 20 | 59 |
| Polymer film | Thickness [μm] | 25 | 40 | 25 | 25 | 25 | 25 | 25 | 25 | 40 | 40 | 25 | 25 |
| | Modulus of elasticity [GPa] | 4.8 | 4.8 | 4.8 | 4.8 | 4.8 | 4.8 | 4.8 | 4.8 | 4.8 | 4.8 | 4.8 | 4.8 |
| Polarizer | Thickness [μm] | 25 | 25 | 15 | 25 | 25 | 25 | 25 | 25 | 25 | 25 | 15 | 15 |
| | Modulus of elasticity [GPa] | 6 | 6 | 6 | 6 | 6 | 6 | 6 | 6 | 6 | 6 | 6 | 6 |
| Inner hardcoat layer | Thickness [μm] | 10 | 10 | 10 | 7.5 | 5 | 7.5 | — | — | — | — | — | — |
| | Modulus of elasticity [GPa] | 3.9 | 3.9 | 3.9 | 4.5 | 3.9 | 3.9 | — | — | — | — | — | — |
| | Hᵢₙ | 39 | 39 | 39 | 34 | 20 | 29 | 0 | 0 | 0 | 0 | 0 | 0 |
| Polarizing plate | Thickness [μm] | 65 | 80 | 55 | 65 | 65 | 65 | 55 | 65 | 70 | 80 | 45 | 45 |

| | | | | | | | | | | | | |
|---|---|---|---|---|---|---|---|---|---|---|---|---|
| Pencil hardness | A | A | A | B | D | C | D | D | D | D | D | D |
| Light resistance | — | A | A | A | A | A | A | A | A | A | A | A |

TABLE 3

| | | | Comparative | | |
|---|---|---|---|---|---|
| | | Examples | Examples | | |
| | | 5 | 9 | 10 | 11 |
| Outer | Thickness [μm] | 5 | 10 | 7.5 | 9 |
| hardcoat | Modulus of elasticity [GPa] | 3.9 | 3.9 | 3.9 | 3.9 |
| layer | Hₒᵤₜ | 20 | 39 | 29 | 35 |
| Polarizer | Thickness [μm] | 25 | 25 | 25 | 25 |
| | Modulus of elasticity [GPa] | 6 | 6 | 6 | 6 |
| Inner | Thickness [μm] | 10 | 5 | 7.5 | 9 |
| hardcoat | Modulus of elasticity [GPa] | 3.9 | 3.9 | 3.9 | 3.9 |
| layer | Hᵢₙ | 39 | 20 | 29 | 35 |
| Polarizing | Thickness [μm] | 40 | 40 | 40 | 44 |
| plate | | | | | |

| | | | | |
|---|---|---|---|---|
| Pencil hardness | A | C | B | A |
| Light resistance | B | B | B | B |

From the above-described results, it was found that, in a case in which the inner hardcoat layer and the outer hardcoat layer do not satisfy the relationship of Expression (I), the pencil hardness of the surface of the polarizing plate decreases (Comparative Examples 1 to 10).

In contrast, it was found that, in a case in which the inner hardcoat layer and the outer hardcoat layer satisfy the relationship of Expression (I), the pencil hardness of the surface of the polarizing plate is excellent (Examples 1 to 5).

In addition, from comparison between Example 5 and Comparative Example 11, it was found that, even when the pencil hardness is similar, the thickness can be decreased by approximately 10% by changing the thicknesses of the inner hardcoat layer and the outer hardcoat layer so as to satisfy Expression (I).

In addition, from the comparison results of Examples 1 to 4, it was found that, in a case in which the inner hardcoat layer and the outer hardcoat layer satisfy the relationship of Expression (I), the pencil hardness of the surface of the polarizing plate is excellent regardless of the presence or absence of the polymer film, the film thickness of the polymer film, and the film thickness of the polarizer.

In addition, from the comparison results of Examples 1 to 4 and Example 5, it was found that, when the polymer film is provided, the light resistance improves.

In addition, from the comparison results of Examples 1 to 3 and Example 4, it was found that, in a case in which the thickness of the inner hardcoat layer is larger than the thickness of the outer hardcoat layer, the pencil hardness becomes more favorable.

### EXPLANATION OF REFERENCES

1: outer hardcoat layer
2: front-side polarizer
3: inner hardcoat layer
4: liquid crystal cell
5: polymer film
6: outer hardcoat layer
7: rear-side polarizer
8: inner hardcoat layer
9: polymer film
10: liquid crystal display device
20: front-side polarizing plate
30: rear-side polarizing plate

What is claimed is:

1. A polarizing plate comprising:
an outer hardcoat layer;
a polarizer; and
an inner hardcoat layer in this order,
wherein the polarizing plate forms an image display device by providing a display element on a side opposite to a side of the inner hardcoat layer on which the polarizer is present,
the inner hardcoat layer and the outer hardcoat layer satisfy a relationship of Expression (I) below, and
a thickness is 80 μm or smaller,
Hᵢₙ>Hₒᵤₜ Expression (I)
here, Hᵢₙ represents a value of a thickness×a modulus of elasticity of the inner hardcoat layer, and Hₒᵤₜ represents a value of a thickness×a modulus of elasticity of the outer hardcoat layer.

2. The polarizing plate according to claim 1,
wherein at least one polymer film is provided between the outer hardcoat layer and the polarizer.

3. The polarizing plate according to claim 1,
wherein the thickness of the inner hardcoat layer is larger than the thickness of the outer hardcoat layer.

4. The polarizing plate according to claim 1,
wherein the outer hardcoat layer is provided on a surface of the polarizer.

5. The polarizing plate according to claim 3,
wherein the outer hardcoat layer is provided on a surface of the polarizer.

6. The polarizing plate according to claim 1,
wherein a thickness of the polarizer is 25 μm or smaller.

7. The polarizing plate according to claim 2,
wherein a thickness of the polarizer is 25 μm or smaller.

8. The polarizing plate according to claim 3,
wherein a thickness of the polarizer is 25 μm or smaller.

9. The polarizing plate according to claim 1,
wherein the modulus of elasticity of the inner hardcoat layer and the modulus of elasticity of the outer hardcoat layer are respectively in a range of 1 GPa to 6 GPa.

10. The polarizing plate according to claim 2,
wherein the modulus of elasticity of the inner hardcoat layer and the modulus of elasticity of the outer hardcoat layer are respectively in a range of 1 GPa to 6 GPa.

11. The polarizing plate according to claim 3,
wherein the modulus of elasticity of the inner hardcoat layer and the modulus of elasticity of the outer hardcoat layer are respectively in a range of 1 GPa to 6 GPa.

12. The polarizing plate according to claim 1,
wherein a value of a ratio between the thickness of the inner hardcoat layer and the thickness of the outer hardcoat layer is in a range of greater than 1 to 5.

13. The polarizing plate according to claim 2,
wherein a value of a ratio between the thickness of the inner hardcoat layer and the thickness of the outer hardcoat layer is in a range of greater than 1 to 5.

14. The polarizing plate according to claim 3,
wherein a value of a ratio between the thickness of the inner hardcoat layer and the thickness of the outer hardcoat layer is in a range of greater than 1 to 5.

15. The polarizing plate according to claim 2,
wherein a thickness of the polymer film is 40 μm or smaller.

16. The polarizing plate according to claim 3,
wherein a thickness of the polymer film is 40 μm or smaller.

17. The polarizing plate according to claim 2,
wherein the polymer film includes at least one resin material selected from a group consisting of cellulose acylate-based resins, acrylic resins, cycloolefin-based resins, and polyester-based resins.

18. The polarizing plate according to claim 3,
wherein the polymer film includes at least one resin material selected from a group consisting of cellulose acylate-based resins, acrylic resins, cycloolefin-based resins, and polyester-based resins.

19. An image display device comprising:
the polarizing plate according to claim 1; and
a display element.

20. An image display device comprising:
the polarizing plate according to claim 2; and
a display element.

21. An image display device comprising:
the polarizing plate according to claim 3; and
a display element.

22. An image display device comprising:
a liquid crystal cell; and a pair of polarizing plates disposed so as to sandwich the liquid crystal cell,
wherein at least one of a pair of the polarizing plates is the polarizing plate according to claim 1.

23. An image display device comprising:
a liquid crystal cell; and a pair of polarizing plates disposed so as to sandwich the liquid crystal cell,
wherein at least one of a pair of the polarizing plates is the polarizing plate according to claim 2.

24. An image display device comprising:
a liquid crystal cell; and a pair of polarizing plates disposed so as to sandwich the liquid crystal cell,
wherein at least one of a pair of the polarizing plates is the polarizing plate according to claim 3.
